(19) United States
(12) Patent Application Publication
(10) Pub. No.: US 2006/0007809 A1
(43) Pub. Date: Jan. 12, 2006

(54) Optical pickup

(76) Inventors: Shinichi Hamaguchi, Hyogo (JP); Masahiko Nishimoto, Osaka (JP); Tatsuya Nakamori, Kyoto (JP); Yasuyuki Kochi, Osaka (JP)

Correspondence Address: MCDERMOTT WILL & EMERY LLP, 600 13TH STREET, N.W., WASHINGTON, DC, 20005-3096, US

(21) Appl. No.: 10/526,964

(22) PCT Filed: Sep. 8, 2003
(86) PCT No.: PCT/JP03/11465

§ 371 Date: Mar. 7, 2005

(30) Foreign Application Priority Data
Sep. 10, 2002 (JP) 2002-264539

(51) Int. Cl. G11B 7/00

(52) U.S. Cl. 369/44.37; 369/44.41; 369/44.27

(57) ABSTRACT

There is provided an optical pickup compliant with a three-beam method, a phase difference method, a push-pull method and a three-beam push-pull method, comprising: an emission light source (105) for emitting two or more light components of different wavelengths; a diffraction element (107); a light collector (103); a hologram element (108); a plurality of photodetectors (206); and operation means for performing an operation on outputs of the plurality of photodetectors (206). The plurality of photodetectors (206) are at least eight photodetectors (P1 to P8) which are necessary for the execution of the three-beam method, the phase difference method, and the push-pull method. The operation means includes a switch (212) for switching between a terminal for obtaining a sub signal of the three-beam push-pull method and a terminal for obtaining a tracking signal of the three-beam method.

### TECHNICAL FIELD

The present invention relates to an optical pickup. Specifically, the present invention relates to an optical pickup (optical head) capable of recording, reproducing or erasing information on an optical or magneto-optical medium, such as an optical disc, an optical card, or the like.

### BACKGROUND ART

The optical memory techniques which use an optical disc having a pit-shape pattern as a high-density, large-capacity recording medium have been applied to a wider variety of products, such as digital audio discs, video discs, document file discs, data files, etc. According to the optical memory techniques, information is recorded on/reproduced from an optical disc through an optical beam of a very small diameter with high accuracy and reliability. This recording/reproducing operation only depends on an optical system used. The optical head, which is the primary part of the optical system, has the basic functions which are generally classified into the following systems: light collection which realizes a tiny spot defined by the diffraction limit; focusing control and tracking control of the optical system; and detection of a pit signal. These functions are realized by a combination of various optical systems and a photoelectric detection method according to the purpose and use. Especially in recent years, an optical pickup which uses a hologram for the purpose of reducing the size and thickness of the optical pickup has been disclosed (see, for example, Japanese Unexamined Patent Publication No. 2001-68779).

FIG. 10 is a schematic cross-sectional view which illustrates a conventional optical pickup disclosed in Japanese Unexamined Patent Publication No. 2001-68779.

The optical pickup 101 includes a semiconductor laser 105 which is an emission light source. The semiconductor laser 105 is supported by a supporting member 109. The supporting member 109 has a photodetector 106. The semiconductor laser 105 is controlled by a system controller (not shown) to selectively emit a light beam of a first wavelength and a light beam of a second wavelength according to the type of an information recording medium 102.

FIG. 11 schematically shows a conventional optical integrated element provided in the optical pickup disclosed in Japanese Unexamined Patent Publication No. 2001-68779.

A light beam LA or LB emitted by the semiconductor laser 105 toward the information recording medium 102 is diffracted by a diffraction element 107 to form three beams of 0th order light, +1st order light and −1st order light. The three beams formed by the diffraction element 107 are collected by light collection means 103 to impinge on the information recording medium 102 and reflected by the information recording medium 102A or 102B. The light reflected by the information recording medium 102A or 102B is collected by the light collection means 103 to enter a hologram element 108. The light that has entered the hologram element 108 is diffracted to selectively enter the photodetector 106. Receiving the light, the photodetector 106 outputs a signal according to the amount of received light. The optical integrated element 104 generates a tracking control signal, or the like, as necessary. The optical integrated element 104 includes the photodetector 106 such that a tracking control signal can be generated according to the type of the information recording medium 102. Japanese Unexamined Patent Publication No. 2001-68779 describes, as a tracking control method, the three-beam method, the phase difference method and the push-pull method. The signals of these methods are obtained by the following operations of the output signals of respective regions:
Three beam method: (E−F) (Expression 1)
Phase difference method: (A+D)−(B+C) (Expression 2)
Push-pull method: (A+B+L)−(C+D+M) (Expression 3)

However, in the above structure, in the case of performing tracking control of the three-beam method, the phase difference method and the push-pull method, it is necessary to provide photodetectors E and F exclusively used for the three-beam method and photodetectors L and M exclusively used for the push-pull method as shown in FIG. 11(b). Accordingly, the size of the entire photodetector increases.

The above structure is not applicable to a known three-beam push-pull method, which is one of the tracking control methods. Thus, the above structure cannot achieve reproduction, recording or erasure of information on an information recording medium in which tracking control is performed using the three-beam push-pull method, such as a DVD, or the like.

In the case where different tracking control operations on different types of optical discs, a greater number of output terminals are required.

In the above structure, the use efficiency of light is low because only 1st order diffracted light from the hologram element is used.

The present invention was conceived in view of the above problems. A primary objective of the present invention is to provide an optical pickup capable of different types of tracking control with the same structure without increasing the entire size of a photodetector. Another objective of the present invention is to provide an optical pickup of high light use efficiency which is capable of different types of tracking control with the same structure without increasing the entire size of a photodetector or increasing the number of output terminals.

### DISCLOSURE OF INVENTION

An optical pickup of the present invention is compliant with a three-beam method, a phase difference method, a push-pull method and a three-beam push-pull method and comprises: an emission light source for emitting two or more light components of different wavelengths; a diffraction element for diffracting the emitted light components; a light collector for collecting the light components output from the diffraction element; a hologram element for diffracting the light components collected by the light collector and then reflected by an information recording medium; a plurality of photodetectors for receiving the diffracted light components output from the hologram element; and operation means for performing an operation on outputs of the plurality of photodetectors. The plurality of photodetectors are at least eight photodetectors which are necessary for the execution of the three-beam method, the phase difference method, and the push-pull method. The operation means includes a switch for switching between a terminal for obtaining a sub signal of the three-beam push-pull method and a terminal for obtaining a tracking signal of the three-beam method.

Another optical pickup of the present invention is compliant with a three-beam method, a phase difference method, a push-pull method and a three-beam push-pull method and comprises: an emission light source for emitting two or more light components of different wavelengths; a diffraction element for diffracting the emitted light components; a light collector for collecting the light components output from the diffraction element; a hologram element for diffracting the light components collected by the light collector and then reflected by an information recording medium; and a plurality of photodetectors for receiving the diffracted light components output from the hologram element. The plurality of photodetectors are at least eight photodetectors which are necessary for the execution of the three-beam method, the phase difference method, and the push-pull method. The optical pickup includes a switch that switches between a first terminal for obtaining a predetermined signal of the three-beam push-pull method and a second terminal for obtaining a predetermined signal of any of the three-beam method, the phase difference method and the push-pull method. The emission light source includes a first emission light source for emitting light of a first wavelength, and a second emission light source for emitting light of a second wavelength which is different from the first wavelength, the second emission light source being placed away from the first emission light source. The hologram element includes at least two diffraction grating regions. At least one of the plurality of photodetectors is placed at a position where diffracted light which is obtained by reflecting light emitted by the first emission light source by the information recording medium and diffracting the reflected light by the hologram element and diffracted light which is obtained by reflecting light emitted by the second emission light source by the information recording medium and diffracting the reflected light by the hologram element are commonly received.

Herein, the “sub signal” means a signal which is output according to diffracted light impinging on a photodetector, the diffracted light being derived from ±1st order diffracted light generated by a diffraction grating and produced by reflecting the ±1st order diffracted light by an information recording medium and diffracting the reflected light by a hologram element.

In a preferred embodiment, a light receiving region which includes the at least eight photodetectors has a division line which extends in a direction generally parallel to a track direction of the information recording medium, and the division line extends across the light receiving region from a front side to a back side of the track direction to divide photodetectors which are adjacent in a direction generally perpendicular to the track direction.

In a preferred embodiment, the first terminal is a terminal for obtaining a sub signal of the three-beam push-pull method; and the second terminal is a terminal for obtaining a tracking signal of the three-beam method.

In a preferred embodiment, the plurality of photodetectors are all placed away from the emission light source and placed at one side with respect to the position of the emission light source which serves as a reference.

In a preferred embodiment, the plurality of photodetectors are placed away from the emission light source; and some of the photodetectors are placed at one side with respect to the position of the emission light source which serves as a reference while the other photodetectors are placed at the other side with respect to the position of the emission light source.

In a preferred embodiment, the first emission light source and the second emission light source are placed such that a line between these light sources extends generally perpendicular to a track direction of the recording information medium.

In a preferred embodiment, the first emission light source and the second emission light source are placed such that a line between these light sources extends generally parallel to a track direction of the recording information medium.

Still another optical pickup of the present invention is compliant with a three-beam method, a phase difference method, a push-pull method and a three-beam push-pull method and comprises: at least eight photodetectors which are necessary for the execution of the three-beam method, the phase difference method, and the push-pull method; a wire for transmitting an output from each of the photodetectors; and a switch that switches between a first terminal on the line for obtaining a predetermined signal of the three-beam push-pull method and a second terminal on the line for obtaining a predetermined signal of any of the three-beam method, the phase difference method and the push-pull method.

In one embodiment, an optical pickup comprises: an emission light source for emitting two or more light components of different wavelengths; a diffraction element for diffracting the emitted light components; light collection means for collecting the light components output from the diffraction element; a hologram element for diffracting the light components collected by the light collection means and then reflected by an information recording medium; a plurality of photodetectors for receiving the diffracted light components output from the hologram element; and operation means for performing an operation on outputs of the plurality of photodetectors. The diffraction element includes a diffraction grating region for diffracting light emitted by the emission light source to generate three beams. The operation means includes a switch for switching the combination of output signals of the photodetectors which are generated from received diffracted light (the diffracted light is obtained by reflecting the three beams by the information recording medium and diffracting the reflected light by the hologram element) according to the type of the information recording medium to be output to a predetermined output terminal.

In one embodiment, the operation means includes a switch for switching the combination of, among the output signals of the photodetectors, output signals generated from received diffracted light which is obtained by reflecting +1st order light and −1st order light of the three beams by the information recording medium and diffracting the reflected light by the hologram element according to the type of the information recording medium to be output to a predetermined output terminal.

According to the present invention, in the process of performing tracking control of different types, a signal to be taken in is switched by a switch, so that a common photodetector can be used. Thus, it is not necessary to increase the entire size of the photodetector. Further, different types of tracking control can be performed with the same structure, and therefore, the use efficiency of light can be improved without increasing the number of output terminals. That is, according to the present invention, although a photodetector arranged for performing the three-beam method, the phase difference method and the push-pull method is used, an optical pickup compliant with the three-beam method, the phase difference method, the push-pull method and the three-beam push-pull method can be realized because the optical pickup includes a switch that switches between a terminal for obtaining a sub signal of the three-beam push-pull method and a terminal for obtaining a tracking signal of the three-beam method. Thus, it is not necessary to increase the entire size of the photodetector.

### BRIEF DESCRIPTION OF DRAWINGS

FIG. 1 is a schematic cross-sectional view of an optical pickup according to embodiment 1 of the present invention.

FIG. 2 shows a structure of an optical integrated element incorporated in the optical pickup according to embodiment 1 of the present invention. FIG. 2(a) is a schematic cross-sectional view. FIG. 2(b) is schematic plan view of a diffraction grating region. FIG. 2(c) is a plan configuration view of a photodetector.

FIG. 3 shows operation means of an optical integrated element according to embodiment 1 of the present invention.

FIG. 4 shows a structure of an optical integrated element incorporated in an optical pickup according to embodiment 2 of the present invention. FIG. 4(a) is a schematic cross-sectional view. FIG. 4(b) is schematic plan view of a diffraction grating region. FIG. 4(c) is a plan configuration view of a photodetector.

FIG. 5 shows operation means of an optical integrated element according to embodiment 2 of the present invention.

FIG. 6 is a schematic perspective view of an optical integrated element incorporated in an optical pickup according to embodiment 3 of the present invention.

FIG. 7 shows a structure of an optical pickup according to embodiment 3 of the present invention. FIG. 7(a) is a schematic cross-sectional view. FIG. 7(b) illustrates the positional relationship between tracks of an information recording medium and the irradiation spot position of 0th order light among three beams.

FIG. 8 is a schematic perspective view of an optical integrated element incorporated in an optical pickup according to embodiment 4 of the present invention.

FIG. 9 shows a structure of an optical pickup according to embodiment 4 of the present invention. FIG. 9(a) is a schematic cross-sectional view. FIG. 9(b) illustrates the positional relationship between tracks of an information recording medium and the irradiation spot position of 0th order light among three beams.

FIG. 10 is a schematic cross-sectional view showing a structure of a conventional optical pickup.

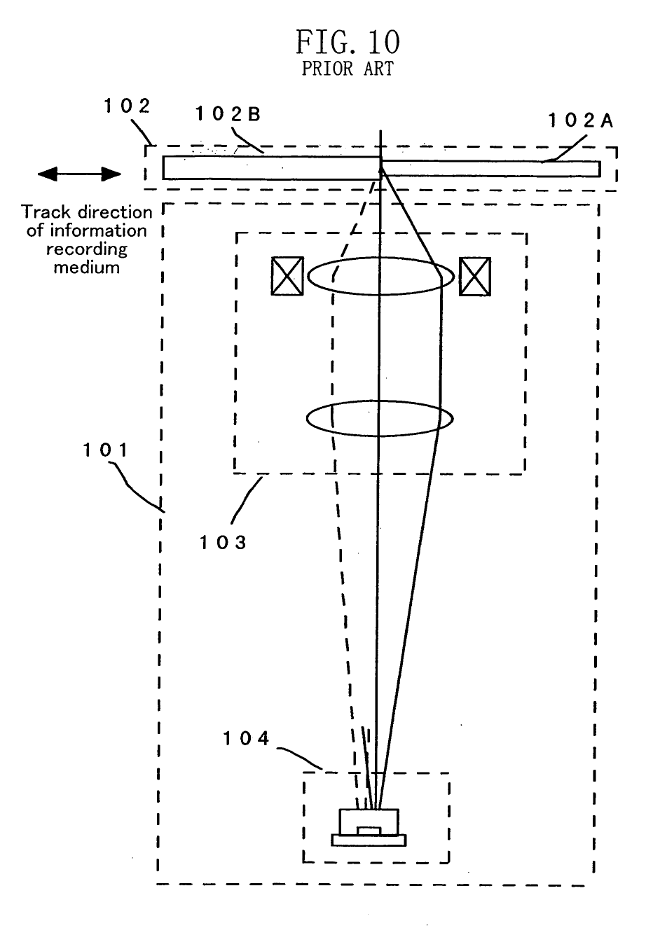

FIG. 11 shows a structure of an optical integrated element incorporated in a conventional optical pickup. FIG. 4(a) is a schematic cross-sectional view. FIG. 11(b) is a plan configuration view of a photodetector.

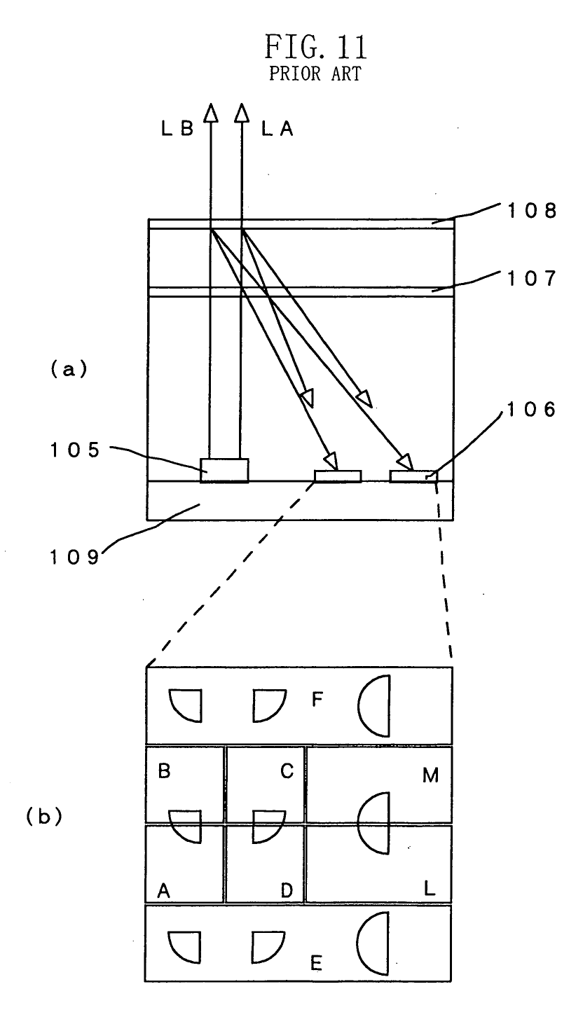

### BEST MODE FOR CARRYING OUT THE INVENTION

Hereinafter, embodiments of the present invention will be described with reference to the drawings. It should be noted that the present invention is not limited to the embodiments described below.

### Embodiment 1

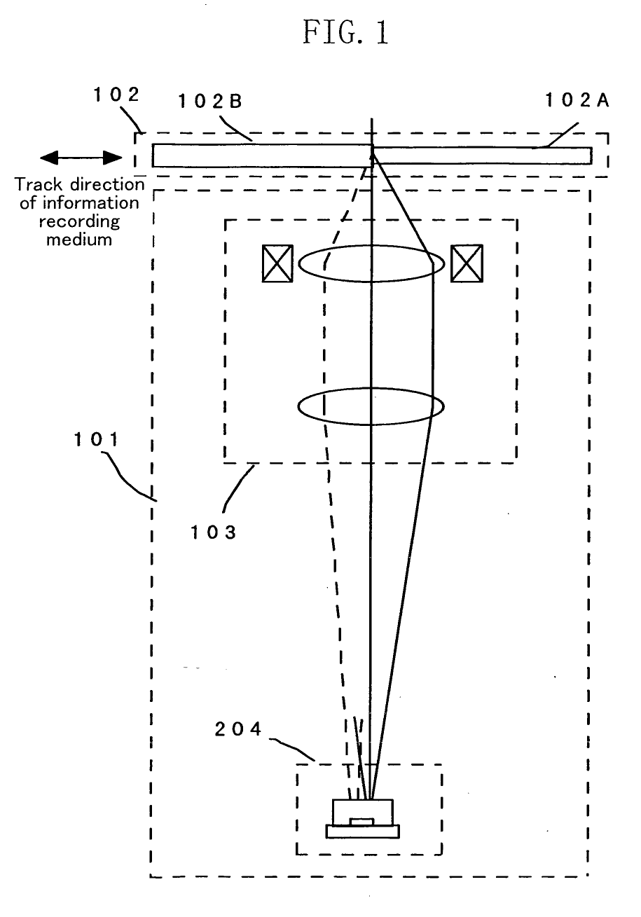

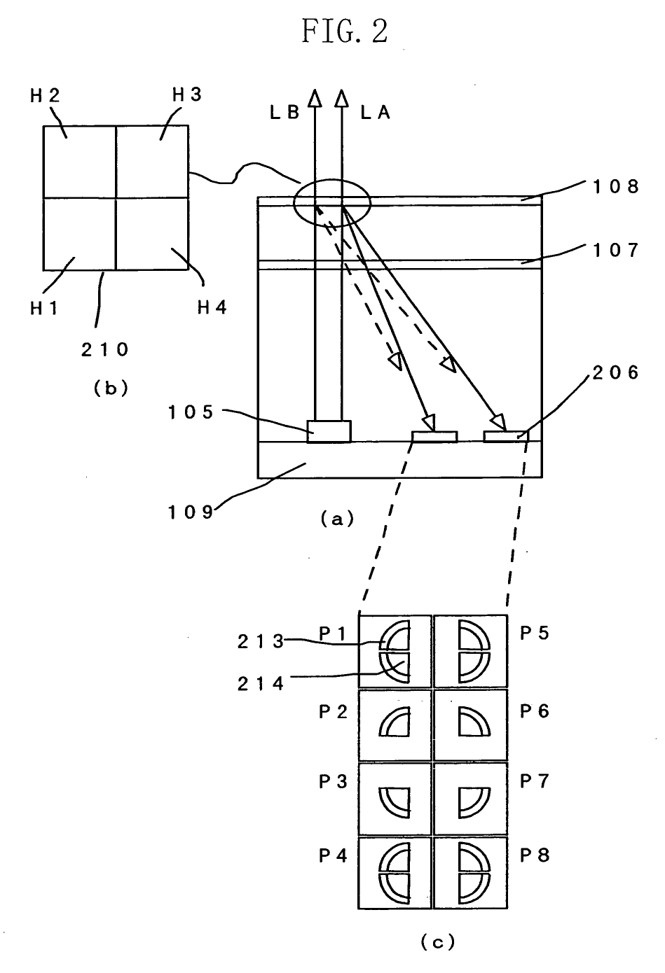

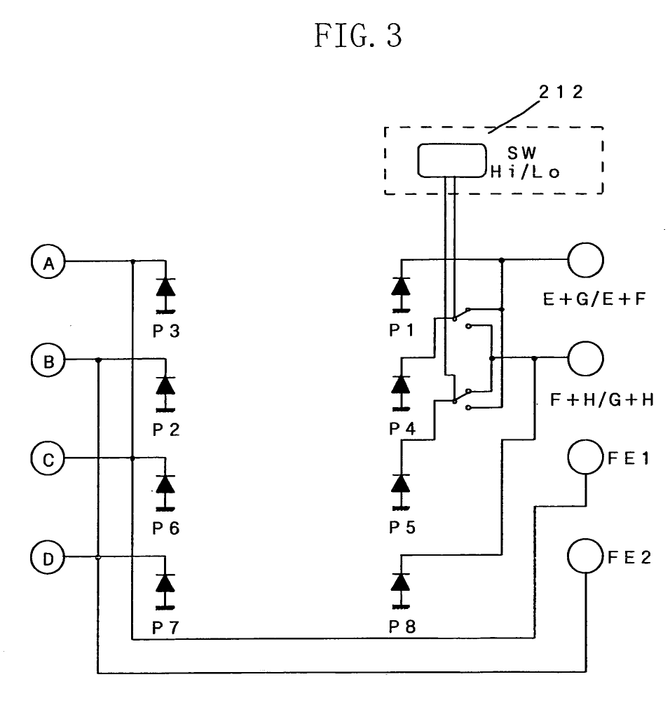

FIG. 1 is a schematic cross-sectional view of an optical pickup according to embodiment 1 of the present invention. FIG. 2 schematically shows an optical integrated element provided in the optical pickup of embodiment 1. FIG. 3 shows operation means of an optical integrated element of embodiment 1.

A light beam LA emitted by an emission light source 105 is branched by a diffraction element 107 into three beams of 0th order light, −1st order light and +1st order light. The branched light are collected by light collection means (light collector) 103 to impinge on an information recording medium 102A. The light is reflected by the information recording medium 102A and diffracted by a diffraction grating region 210 formed in a hologram element 108. The diffracted light output from the hologram element 108 impinges on a photodetector 206. The photodetector 206 has a two-dimensional arrangement shown in FIG. 2(c). The photodetector 206 needs to have at least three photodetectors for receiving the reflected light of 0th order light, +1st order light and −1st order light obtained by the diffraction element 107.

Also in the case where a light beam LB which has a wavelength different from that of the light beam LA is emitted from the emission light source 105, the light beam LB is branched to three beams and then collected in the same way to impinge on an information recording medium 102B. The route of the reflected light to the photodetector 206 is substantially the same.

The optical integrated element 204 has a switch 212. The switch 212 switches, according to the type of the information recording medium, the combination of output signals of the photodetector 206 which are generated when the +1 st order light and −1st order light reflected by the information recording medium 102 and diffracted by the diffraction grating region 210 of the hologram element 108 are received, to output the selected combination of output signals to a predetermined output terminal. The switch 212 of embodiment 1 operates between a first terminal for obtaining a predetermined signal of the three-beam push-pull method and a second terminal for obtaining a predetermined signal of any of the three-beam method, the phase difference method and the push-pull method. More specifically, the switch 212 shown in FIG. 3 operates between a terminal for obtaining a sub signal of the three-beam push-pull method and a terminal for obtaining a tracking signal of the three-beam method.

The return light reflected by the information recording media 102A and 102B, which have two different wavelengths, is further diffracted by the diffraction grating region 210 on the hologram element 108. The diffraction grating region 210 of embodiment 1 has a structure described below.

The diffraction grating region 210 always functions as follows for the return light irrespective of the wavelength. The 0th order return light included in the three beams selectively impinges on the photodetectors such that a light component diffracted by a region H1 impinges on a photodetector P3, a light component diffracted by a region H2 impinges on a photodetector P2, a light component diffracted by a region H3 impinges on a photodetector P6, and a light component diffracted by a region H4 impinges on a photodetector P7. The +1st order return light included in the three beams selectively impinges on the photodetectors such that light components diffracted by regions H1 and H2 impinge on a photodetector P1, and light components diffracted by regions H3 and H4 impinge on a photodetector P5. The −1st order return light included in the three beams selectively impinges on the photodetectors such that light components diffracted by regions H1 and H2 impinge on a photodetector P4, and light components diffracted by regions H3 and H4 impinge on a photodetector P8.

With the above structure, the switch 212 is caused to selectively operate such that tracking control of the three-beam method, the phase difference method, the push-pull method and the three-beam push-pull method is performed by the operations of expressions (4) to (7) shown below based on output signals A to H of the photodetectors P1 to P8 (A=P3, B=P2, C=P6, D=P7, E=P1, F=P5, G=P4, H=P8). It is not necessary to increase the entire size of the photodetectors or increase the number of output terminals.
Three-beam method: (E+F)−(G+H) (SW:Lo) (Expression 4)
Phase difference method: (A+C)−(B+D) (Expression 5)
Push-pull method: (A+B)−(C+D) (Expression 6)
Three-beam push-pull method: {(A+B)−(C+D)}−k{(E+G)−(F+H)} (Expression 7)
k is any value (SW:Hi)

In the structure of embodiment 1, signal FE for focus control based on, for example, the Foucault method or astigmatism method, which is equal to FE1-FE2 (FE=FE1−FE2) where FE1=(A+C) and FE2=(B+D), can be generated. Further, a sum signal of one or more outputs from the photodetectors is used, whereby a RF signal can be generated.

In embodiment 1, the supporting member 109 may be a semiconductor substrate. A photodetector may be formed integrally in the semiconductor substrate.

In the above example, the emission light source 105 is an emission light source wherein two or more light components are emitted from one chip. However, the emission light source may be such that light is emitted from two or more chips.

In the above example, the optical integrated element integrally includes the emission light source 105, the photodetector 206, the diffraction element 107 and the hologram element 108. However, these components may be separate from one another.

### Embodiment 2

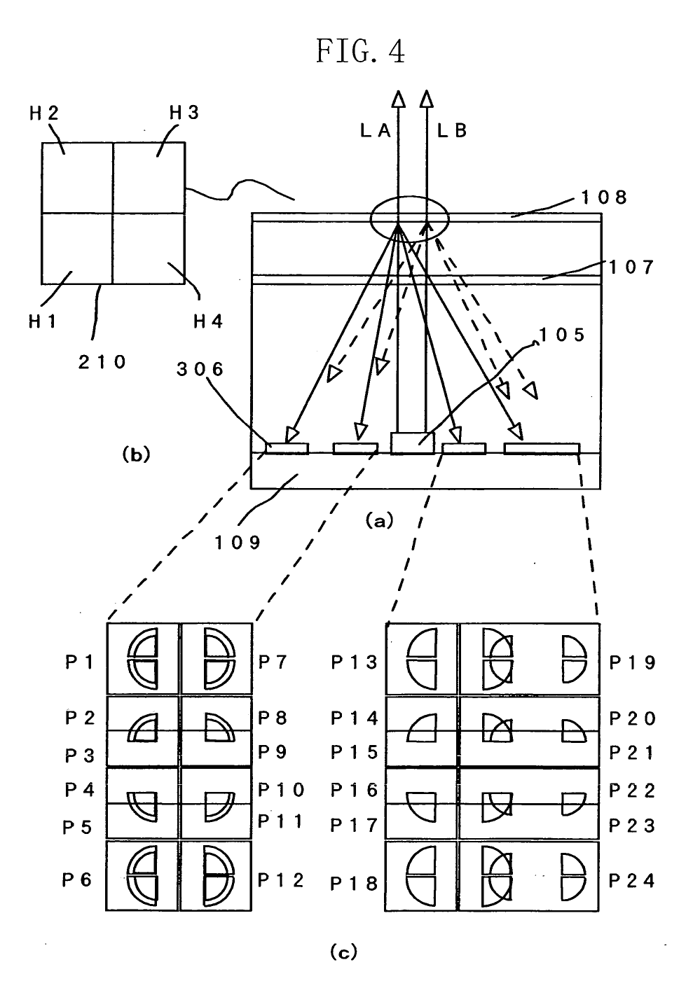

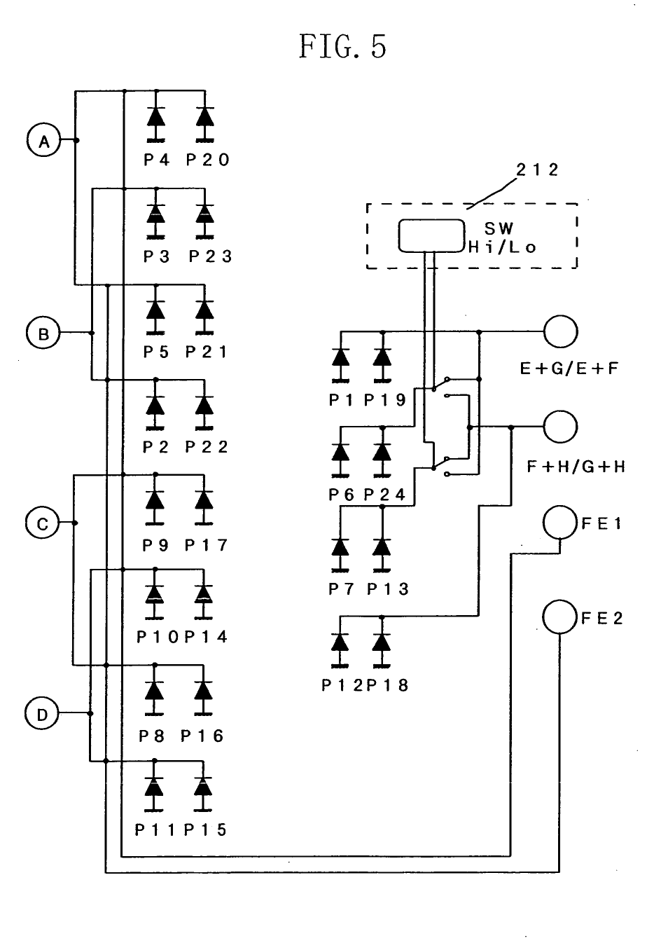

FIG. 4 schematically shows an optical integrated element incorporated in an optical pickup according to embodiment 2 of the present invention. FIG. 5 shows operation means of an optical integrated element according to embodiment 2.

A light beam LA emitted by an emission light source 105 is branched by a diffraction element 107 into three beams of 0th order light, −1st order light and +1st order light. The branched light are collected by light collection means 103 to impinge on an information recording medium 102A. The light is reflected by the information recording medium 102A and diffracted by a diffraction grating region 210 formed in a hologram element 108. The diffracted light output from the hologram element 108 impinges on a photodetector 306. The photodetector 306 has a two-dimensional arrangement shown in FIG. 4(c).

Also in the case where a light beam LB which has a wavelength different from that of the light beam LA is emitted from the emission light source 105, the light beam LB is branched to three beams and then collected in the same way to impinge on an information recording medium 102B. The light is reflected by the information recording medium 102B and diffracted by the diffraction grating region 210. The diffracted light then impinges on the photodetector 306.

The return light reflected by the information recording media 102A and 102B, which have two different wavelengths, is further diffracted by the diffraction grating region 210 on the hologram element 108. The diffraction grating region 210 of embodiment 2 has a structure described below.

The diffraction grating region 210 always functions for the return light irrespective of the wavelength such that, among the photodetectors 306 provided at both sides of the emission light source 105, the photodetectors at one side (photodetectors P1 to P12 of FIG. 4(c)) receive diffracted light at substantially the same positions whereas the photodetectors at the other side (photodetectors P13 to P24 of FIG. 4(c)) receive diffracted light at different positions according to the wavelength.

Specifically, as for the light beam LA, the 0th order return light included in the three beams is further diffracted by the diffraction grating region 210 to selectively impinge on the photodetectors such that +1st order diffracted light output from a region H1 impinges on photodetectors P4 and P5, −1st order diffracted light output from the region H1 impinges on photodetectors P20 and P21, +1st order diffracted light output from a region H2 impinges on photodetectors P2 and P3, −1st order diffracted light output from the region H2 impinges on photodetectors P22 and P23, +1st order diffracted light output from a region H3 impinges on photodetectors P8 and P9, −1st order diffracted light output from the region H3 impinges on photodetectors P16 and P17, +1st order diffracted light output from a region H4 impinges on photodetectors P10 and P11, and −1st order diffracted light output from the region H4 impinges on photodetectors P14 and P15. The +1st order return light included in the three beams is further diffracted by the diffraction grating region 210 to selectively impinge on the photodetectors such that +1st order diffracted light output from the regions H1 and H2 impinges on a photodetector P1, −1st order diffracted light output from the regions H1 and H2 impinges on a photodetector P19, +1st order diffracted light output from the regions H3 and H4 impinges on a photodetector P7, and −1st order diffracted light output from the regions H3 and H4 impinges on a photodetector P13. The −1st order return light included in the three beams is further diffracted by the diffraction grating region 210 to selectively impinge on the photodetectors such that +1st order diffracted light output from the regions H1 and H2 impinges on a photodetector P6, −1st order diffracted light output from the regions H1 and H2 impinges on a photodetector P24, +1st order diffracted light output from the regions H3 and H4 impinges on a photodetector P12, and −1st order diffracted light output from the regions H3 and H4 impinges on a photodetector P18.

As for the light beam LB, the 0th order return light included in the three beams is further diffracted by the diffraction grating region 210 to selectively impinge on the photodetectors such that +1st order diffracted light output from a region H1 impinges on photodetectors P4 and P5, −1st order diffracted light output from the region H1 impinges on photodetectors P20 and P21, +1st order diffracted light output from a region H2 impinges on photodetectors P2 and P3, −1st order diffracted light output from the region H2 impinges on photodetectors P22 and P23, +1st order diffracted light output from a region H3 impinges on photodetectors P8 and P9, −1st order diffracted light output from the region H3 impinges on photodetectors P22 and P23, +1 st order diffracted light output from a region H4 impinges on photodetectors P10 and P11, and −1st order diffracted light output from the region H4 impinges on photodetectors P20 and P21. The +1st order return light included in the three beams is further diffracted by the diffraction grating region 210 to selectively impinge on the photodetectors such that +1st order diffracted light output from the regions H1 and H2 impinges on a photodetector P1, −1st order diffracted light output from the regions H1 and H2 impinges on a photodetector P19, +1st order diffracted light output from the regions H3 and H4 impinges on a photodetector P7, and −1st order diffracted light output from the regions H3 and H4 impinges on a photodetector P19. The −1st order return light included in the three beams is further diffracted by the diffraction grating region 210 to selectively impinge on the photodetectors such that +1st order diffracted light output from the regions H1 and H2 impinges on a photodetector P6, −1st order diffracted light output from the regions H1 and H2 impinges on a photodetector P24, +1st order diffracted light output from the regions H3 and H4 impinges on a photodetector P12, and −1st order diffracted light output from the regions H3 and H4 impinges on a photodetector P24.

With the above structure, output signals from the respective regions of the photodetector 306 are combined as follows to achieve various tracking control:
A=P4+P5+P20+P21 (Expression 8)
B=P2+P3+P22+P23 (Expression 9)
C=P8+P9+P16+P17 (Expression 10)
D=P10+P11+P14+P15 (Expression 11)
E=P1+P19 (Expression 12)
F=P7+P13 (Expression 13)
G=P6+P24 (Expression 14)
H=P12+P18 (Expression 15)
FE1=P3+P4+P9+P10+P14+P17+P20+P23 (Expression 16)
FE2=P2+P5+P8+P11+P15+P16+P21+P22 (Expression 17)

The above signals are subjected to operations to generate the following tracking control signals:
Three-beam method: (E+F)−(G+H) (SW:Lo) (Expression 18)
Phase difference method: (A+C)−(B+D) (Expression 19)
Push-pull method: (A+B)−(C+D) (Expression 20)
Three-beam push-pull method: {(A+B)−(C+D)}−k{(E+G)−(F+H)} (Expression 21)
k is any value (SW:Hi)

According to embodiment 2, the entire size of photodetectors is not increased, and the number of output terminals is not increased.

With the structure of embodiment 2, it is possible to generate signal FE (FE1−FE2) which is used for the focus control based on the SSD method, for example. Further, an addition signal of one or more outputs from the photodetector 306 is used to generate a RF signal.

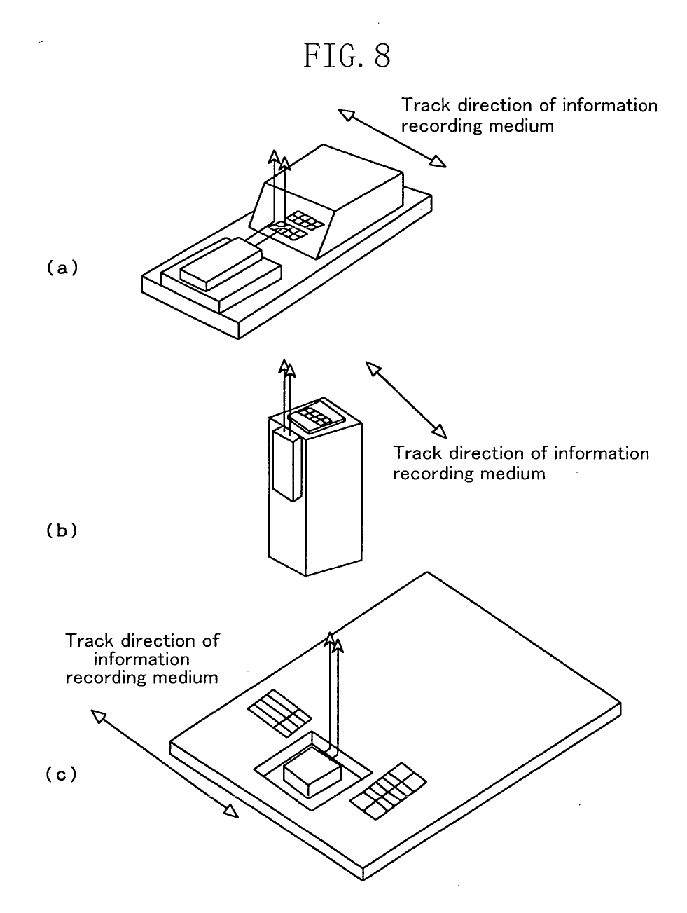

In the example of embodiment 2, among the three beams produced by the diffraction grating 107, ±1st order reflected light is further diffracted by the diffraction grating region 210, and resultant ±1st order light components are used. However, only the +1st or −1st order diffracted light generated by further diffracting the light with the diffraction grating region 210 may be used. In such a case, the output signals from the light receiving regions P13, P18, P19 and P24 shown in FIG. 4(c) are not used, and therefore, it is not necessary to form these regions. An example of a pattern having no such region is shown in FIG. 8(c).

The diffraction angle at the hologram element 108 differs according to the difference in wavelength. Therefore, −1st order light is collected at difference positions even if +1st order light is collected at the same position. However, diffracted light derived from light of any wavelength can be efficiently used by increasing the number of light receiving elements at a side where −1st order light is diffracted along a line that includes light emission positions of the emission light source or increasing the length of the light receiving elements along the line.

In the above example, the SSD method has been described as the focus control method. However, the present invention is widely applicable to, for example, the Foucault method, the astigmatism method, or the like, by changing the combination of the signals which are output from the photodetectors for determining values FE1 and FE2.

In embodiment 2, the supporting member 109 may be a semiconductor substrate. A photodetector may be formed integrally in the semiconductor substrate.

In the above example, the emission light source 105 is an emission light source wherein two or more light components are emitted from one chip. However, the emission light source may be such that light is emitted from two or more chips.

In the above example, the optical integrated element integrally includes the emission light source 105, the photodetector 306, the diffraction element 107 and the hologram element 108. However, these components may be separate from one another.

### Embodiment 3

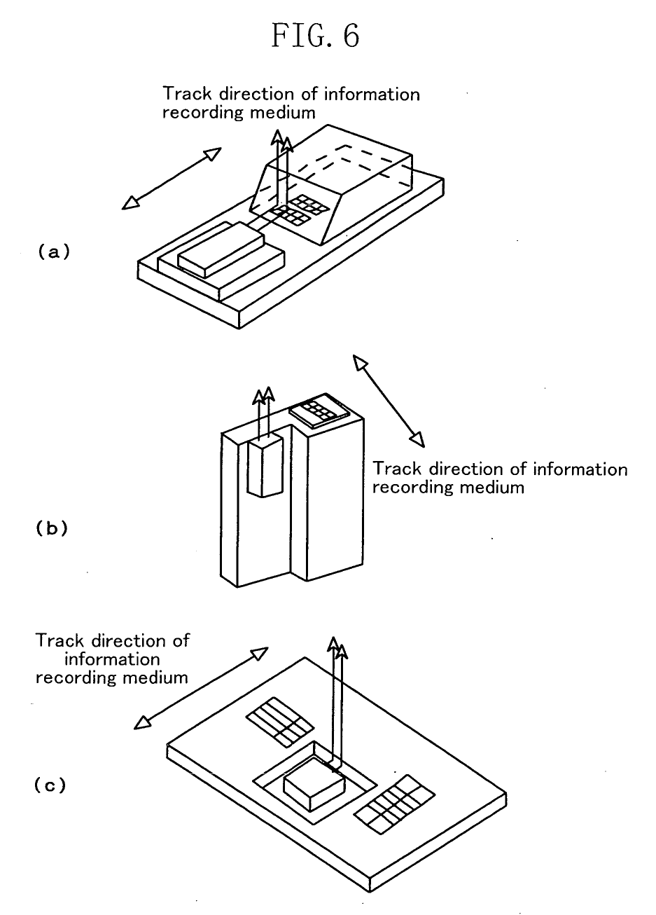

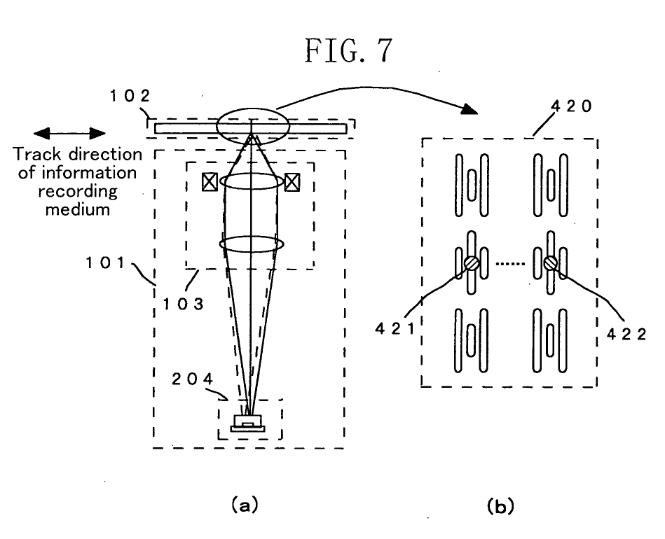

FIG. 6 schematically shows an optical integrated element incorporated in an optical pickup according to embodiment 3 of the present invention. FIG. 7 schematically shows the optical pickup of embodiment 3.

In the examples of FIGS. 6 and 7, an emission light source 105 is placed such that a line including emission points of the emission light source 105 from which light of different wavelengths are emitted is substantially perpendicular to the track direction of an information recording medium 102.

Since in embodiment 3 the emission light source 105 is placed such that a line including emission points of the emission light source 105 from which light of different wavelengths are emitted is substantially perpendicular to the track direction of an information recording medium 102, two light beams LA and LB of different wavelengths impinge on the information recording medium 102 at different track positions to form spots 421 and 422 as shown in FIG. 7(b). It should be noted that, for convenience of illustration, only the spots of 0th order light generated by the diffraction element 107 are shown.

For example, on the information recording medium 102, a spot derived from the light beam LA is formed on a line including the emission point of the emission light source 105 from which the light beam LA is emitted and the center of the light collection means 103. A spot derived from the light beam LB is formed on a position away from the spot of the light beam LA which correlates to the interval between the emission points of the light beams LA and LB and the optical magnification of the light collection means 103. In this case, the optical magnification of the light collection means 103 is set to a predetermined value such that the light spots of the light beams LA and LB can be appropriately formed on tracks even if information is reproduced from, recorded on, or erased from information recording media of different types using light beams of different wavelengths. Further, the photodetectors are placed at substantially the same positions as those of embodiments 1 and 2, whereby tracking control of the three-beam method, the phase difference method, the push-pull method and the three-beam push-pull method can be performed with the same photodetectors.

### Embodiment 4

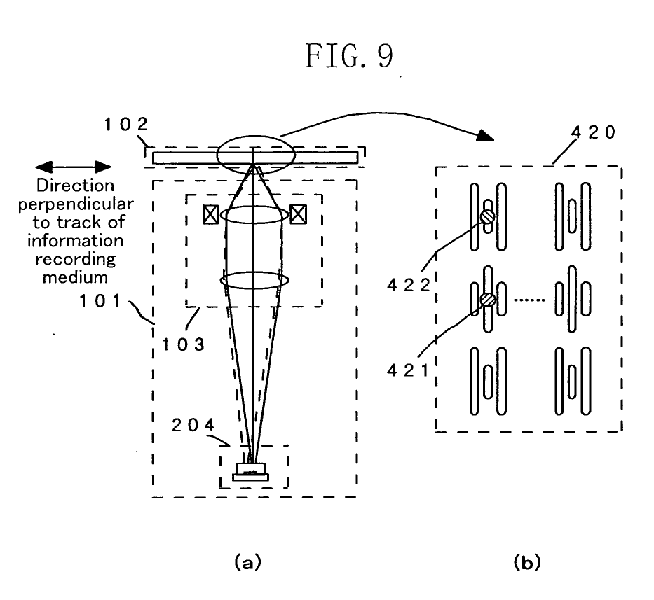

FIG. 8 schematically shows an optical integrated element incorporated in an optical pickup according to embodiment 4 of the present invention. FIG. 9 schematically shows the optical pickup of embodiment 4.

In the examples of FIGS. 8 and 9, an emission light source 105 is placed such that a line including emission points of the emission light source 105 from which light of different wavelengths are emitted is substantially parallel to the track direction of an information recording medium 102.

Since in embodiment 4 the emission light source 105 is placed such that a line including emission points of the emission light source 105 from which light of different wavelengths are emitted is substantially parallel to the track direction of an information recording medium 102, two light beams LA and LB of different wavelengths impinge on the information recording medium 102 at substantially the same track position to form spots 421 and 422 as shown in FIG. 9(b). It should be noted that, for convenience of illustration, only the spots of 0th order light generated by the diffraction element 107 are shown.

The optical pickup 101 generally has a structure, in many cases, such that a part or the entirety of the light collection means 103 is movable in a direction perpendicular to a track of the information recording medium 102 but unmovable in a direction parallel to a track of the information recording medium 102. In such a case, if the above-described structure of embodiment 3 is employed, a part or the entirety of the light collection means 103 is movable for, for example, the light beam LA with respect to the emission light source of the light beam LA as a center. However, as for the light beam LB, a part or the entirety of the light collection means 103 is unmovable with respect to the emission light source of the light beam LB as a center. Thus, a part or the entirety of the light collection means 103 is moved with respect to the emission light source of the light beam LA as a center.

Therefore, when a part or the entirety of the light collection means 103 is moved, the output signals derived from the light beam LA are symmetrical with respect to the emission light source of the light beam LA. Thus, an offset is unlikely to occur in a signal that is used for tracking control. However, the output signals derived from the light beam LB are not symmetrical with respect to the emission light source of the light beam LB. Thus, an offset is likely to occur in a signal that is used for tracking control. As a result, in an optical integrated element or optical pickup including an emission light source which emits two light components of different wavelengths, it is difficult to achieve more precise tracking control.

However, according to the embodiment 4, the spots of the light beams LA and LB are formed at substantially the same track position on the information recording medium 102, and therefore, when a part or the entirety of the light collection means 103 is moved, the output signals of the light beams LA and LB are symmetrical with respect to the emission light sources of the light beams LA and LB. Thus, an offset is unlikely to occur in a signal that is used for tracking control. As a result, in an optical integrated element or optical pickup 101 including an emission light source which emits two light components of different wavelengths, more precise tracking control can be achieved.

In embodiment 4, the photodetector is placed at substantially the same position as that determined in embodiments 1 and 2, so that tracking control of the three-beam method, the phase difference method, the push-pull method and the three-beam push-pull method can be achieved using the same photodetector.

In the above embodiments, a switch that switches between a terminal for obtaining a sub signal of the three-beam push-pull method and a terminal for obtaining a tracking signal of the three-beam method has been described as an example of the switch 212, but the present invention is not limited thereto. According to the present invention, a common photodetector can be used. In view of the unnecessity of changing the entire size of a photodetector, a switch only need to operate such that the combination of output signals of photodetectors which are generated from received diffracted light (the diffracted light is obtained by reflecting the three beams by the information recording medium and diffracting the reflected light by the hologram element) is changed according to the type of an information recording medium to be output to a predetermined output terminal.

As described above, according to an optical pickup of the present invention, in the process of reproduction, recording or erasure of information on information recording media of different types using an emission light source which emits two or more light components of different wavelengths, some of the output signals of photodetectors are switched by a switch according to the type of the information recording media to be output to an output terminal. Thus, a common photodetector can be used, and it is not necessary to change the entire size of a photodetector. Further, even in the case of performing tracking control of different types, it is not necessary to increase the number of output terminals, and the use efficiency of light is high. Thus, it is possible to provide an optical pickup having a simple structure.

### INDUSTRIAL APPLICABILITY

An optical pickup of the present invention has a structure wherein some of the output signals of photodetectors are switched by a switch according to the type of an information recording medium to be output to an output terminal. Thus, a common photodetector can be used, and it is not necessary to change the entire size of the photodetector. In view of such advantages, it can be said that the present invention has high industrial applicability.

1. An optical pickup compliant with a three-beam method, a phase difference method, a push-pull method and a three-beam push-pull method, comprising:
an emission light source for emitting two or more light components of different wavelengths;
a diffraction element for diffracting the emitted light components;
a light collector for collecting the light components output from the diffraction element;
a hologram element for diffracting the light components collected by the light collector and then reflected by an information recording medium;
a plurality of photodetectors for receiving the diffracted light components output from the hologram element; and
operation means for performing an operation on outputs of the plurality of photodetectors,
wherein the plurality of photodetectors are at least eight photodetectors which are necessary for the execution of the three-beam method, the phase difference method, and the push-pull method, and
the operation means includes a switch for switching between a terminal for obtaining a sub signal of the three-beam push-pull method and a terminal for obtaining a tracking signal of the three-beam method.

2. An optical pickup compliant with a three-beam method, a phase difference method, a push-pull method and a three-beam push-pull method, comprising:
an emission light source for emitting two or more light components of different wavelengths;
a diffraction element for diffracting the emitted light components;
a light collector for collecting the light components output from the diffraction element;
a hologram element for diffracting the light components collected by the light collector and then reflected by an information recording medium; and
a plurality of photodetectors for receiving the diffracted light components output from the hologram element,
wherein the plurality of photodetectors are at least eight photodetectors which are necessary for the execution of the three-beam method, the phase difference method, and the push-pull method,
the optical pickup includes a switch that switches between a first terminal for obtaining a predetermined signal of the three-beam push-pull method and a second terminal for obtaining a predetermined signal of any of the three-beam method, the phase difference method and the push-pull method,
the emission light source includes
a first emission light source for emitting light of a first wavelength, and
a second emission light source for emitting light of a second wavelength which is different from the first wavelength, the second emission light source being placed away from the first emission light source,
the hologram element includes at least two diffraction grating regions, and
at least one of the plurality of photodetectors is placed at a position where diffracted light which is obtained by reflecting light emitted by the first emission light source by the information recording medium and diffracting the reflected light by the hologram element and diffracted light which is obtained by reflecting light emitted by the second emission light source by the information recording medium and diffracting the reflected light by the hologram element are commonly received.

3. The optical pickup according to claim 1 or 2, wherein:
a light receiving region which includes the at least eight photodetectors has a division line which extends in a direction generally parallel to a track direction of the information recording medium, and
the division line extends across the light receiving region from a front side to a back side of the track direction to divide photodetectors which are adjacent in a direction generally perpendicular to the track direction.

4. The optical pickup according to claim 2, wherein:
the first terminal is a terminal for obtaining a sub signal of the three-beam push-pull method; and
the second terminal is a terminal for obtaining a tracking signal of the three-beam method.

5. The optical pickup according to claim 1 or 2, wherein the plurality of photodetectors are all placed away from the emission light source and placed at one side with respect to the position of the emission light source which serves as a reference.

6. The optical pickup according to claim 1 or 2, wherein:
the plurality of photodetectors are placed away from the emission light source; and
some of the photodetectors are placed at one side with respect to the position of the emission light source which serves as a reference while the other photodetectors are placed at the other side with respect to the position of the emission light source.

7. The optical pickup according to claim 1 or 2, wherein the first emission light source and the second emission light source are placed such that a line between these light sources extends generally perpendicular to a track direction of the recording information medium.

8. The optical pickup according to claim 1 or 2, wherein the first emission light source and the second emission light source are placed such that a line between these light sources extends generally parallel to a track direction of the recording information medium.

9. An optical pickup compliant with a three-beam method, a phase difference method, a push-pull method and a three-beam push-pull method, comprising:
at least eight photodetectors which are necessary for the execution of the three-beam method, the phase difference method, and the push-pull method;
a wire for transmitting an output from each of the photodetectors; and
a switch that switches between a first terminal on the line for obtaining a predetermined signal of the three-beam push-pull method and a second terminal on the line for obtaining a predetermined signal of any of the three-beam method, the phase difference method and the push-pull method.
